(19) United States
(12) Patent Application Publication
(10) Pub. No.: US 2014/0044938 A1
(43) Pub. Date: Feb. 13, 2014

(54) Process for producing a COMPONENT-MATCHED PROTECTIVE LAYER and component having such a protective layer

(71) Applicant: MTU AERO ENGINES AG, Munich (DE)

(72) Inventors: Horst PILLHOEFER, Roehrmoos (DE); Erwin BAYER, Dachau (DE); Thomas DAUTL, Weichs (DE); Stefan MUELLER, Munich (DE)

(73) Assignee: MTU AERO ENGINES AG, Munich (DE)

(21) Appl. No.: 13/962,360

(22) Filed: Aug. 8, 2013

(30) Foreign Application Priority Data
Aug. 10, 2012 (EP) 12179980.3

(51) Int. Cl. B05D 7/00

(52) U.S. Cl. CPC B05D 7/00
USPC 428/209; 427/256; 427/250; 205/112; 205/191; 205/184; 205/198; 205/188

(57) ABSTRACT

Disclosed is process for producing a protective layer for protecting a component against high temperatures and aggressive media. The process comprises forming a surface layer comprising aluminum and chromium on a surface of the component to be provided with the protective layer by chromizing and alitizing. The chromizing and/or the alitizing in different regions of the component surface to be protected is carried out simultaneously but differently to result in a protective layer that has different regions.

### CROSS-REFERENCE TO RELATED APPLICATIONS

The present application claims priority under 35 U.S.C. § 119 of European Patent Application No. 12179980.3, filed Aug. 10, 2012, the entire disclosure of which is expressly incorporated by reference herein.

### BACKGROUND OF THE INVENTION

1. Field of the Invention

The present invention relates to a process for producing a protective layer for protecting a component against high temperatures and aggressive media and also a component having such a protective layer, where the protective layer comprises aluminum and chromium. In addition, the invention relates to a component having a corresponding protective layer, in particular a component for a gas turbine or an aircraft engine.

2. Discussion of Background Information

In flow machines such as stationary gas turbines or aircraft engines, components such as guide blades or rotor blades are exposed to both high temperatures and aggressive media or atmospheres which bring about various types of damage such as particle erosion, corrosion and high-temperature oxidation. It is therefore necessary to protect the components against preferably all these types of damage, although compromises may sometimes have to be made since protective measures which are successful for one type of damage can themselves cause severe damage as a result of other damage mechanisms.

For example, protective measures against various corrosion and oxidation attacks simultaneously have not been successful to a satisfactory degree. Thus, corrosion and sulfidation attacks corresponding to type 2 corrosion occur in gas turbines or aircraft engines in the case of components which are subjected to operating temperatures in the range from 550 to 750° C. with deposition of alkali metals or alkaline earth metals. An attack on the material over a large area at temperatures in the range from 750° C. to 900° C. in the presence of sulfur- and chloride-containing potassium, sodium and calcium salts is referred to as type 1 corrosion. At temperatures above 900° C., oxidation attack dominates in the case of nickel-based and cobalt-based cast alloys which are frequently used for components in correspondingly hot regions of a gas turbine or an aircraft engine.

Since it has hitherto not been possible to provide a uniform protective measure for the various damage mechanisms, it has been proposed that protective measures be provided in different regions of the relative component, for example, a turbine blade. Here, WO 2007/140805 A1, the entire disclosure of which is incorporated by reference herein, proposes a plurality of different layer compositions for various regions of turbine components.

However, the production costs for such different coatings on a component are very high since the layers are applied individually in succession and there is a high cost for protective measures for parts which are not to be coated on the components.

In view of the foregoing, it is desirable to have available a process for producing a protective layer for protecting a component against high temperatures and aggressive media and also a corresponding protective layer where the protective layer should withstand various damage mechanisms. In addition, the process should be able to be carried out simply and the protective layer should effect protection against corrosion and oxidation.

### SUMMARY OF THE INVENTION

The present invention provides a process for producing a protective layer for protecting a component against high temperatures and aggressive media. The process comprises forming a surface layer comprising aluminum and chromium on a surface of the component to be provided with the protective layer by (i) chromizing and (ii) alitizing. The chromizing and/or the alitizing in different regions of the component surface to be protected is carried out simultaneously but differently to form a protective layer that has different regions.

In one aspect of the process, for chromizing chromium may be deposited by a thermochemical process or a thermophysical process or an electrochemical process.

In another aspect, a heat treatment may be carried out in (i).

In yet another aspect, during (i) different chromium contents may be deposited in the different regions. For example, chromium contents of the layer formed in the different regions may vary from 15% to 100% by weight.

In a still further aspect, chromium-enriched layers having different thicknesses may be deposited in the different regions during (i). For example, the layer thicknesses in the different regions may vary from 5 μm to 150 μm.

In another aspect of the process of the present invention, (i) may be carried out at a chemical chromium activity of greater than or equal to 0.4 to form a first surface layer. For example, (i) may be carried out using a Cr-rich slip which contains liquid phases and may be applied, in particular, by injection molding. Also, (i) may be carried out in such a way that a chromium-rich layer having an outer α-chromium sublayer and an inner mixed crystal layer essentially composed of chromium and a main constituent which has the largest proportion in the alloy of the coated component is formed. For example, the chromium content of the chromium-rich layer may be greater than or equal to 40% by weight.

In another aspect of the process, (i) may be carried out at a temperature of from 1000° C. to 1200° C., in particular from 1050° C. to 1130° C., for a period of from 1 to 20 hours, in particular from 10 to 15 hours and/or (ii) may be carried out at a temperature of from 1000° C. to 1150° C., in particular from 1050° C. to 1150° C., preferably from 1080° C. to 1100° C., for a period of from 2 to 20 hours, in particular from 9 to 15 hours.

In yet another aspect of the process of of the present invention, the chemical aluminum activity in (ii) may be greater than or equal to 0.15. For example, the chemical aluminum activity may be from 0.15 to 0.35.

In another aspect of the process, a first alitizing may be followed by a second alitizing at a lower chemical aluminum activity, in particular at a chemical aluminum activity of from 0.05 to 0.3, at a temperature of greater than or equal to 1050° C. for a period of from 3 to 20 hours.

In another aspect, (i) and (ii) may be followed by a diffusion heat treatment at a temperature of greater than or equal to 1050° C. for a period of from 2 to 8 hours.

In yet another aspect, a surface treatment by PVD, CVD, surface coating, electrochemical deposition and/or direct application of a material, in which one or more elements selected from platinum, palladium, hafnium, zirconium, yttrium and silicon are applied, may be carried out before, during or after (i) and/or (ii).

The present invention also provides a component, in particular a component for a gas turbine or aircraft engine, which comprises a protective layer produced according to the process of the present invention as set forth above (including the various aspects thereof).

The invention takes up the idea that different protective layers have to be provided on a component which is subjected to different damage mechanisms. However, contrary to the prior art, in which various layers are produced separately in a complicated process, the present invention proposes forming a layer which contains aluminum and chromium and can be different in various regions of the protective layer but whose different regions can be produced in common production steps. Corresponding aluminum-chromium layers can be set by varying the proportion of chromium for various oxidation and corrosion attacks, so that a component can be given effective protection against different damage mechanisms by means of aluminum-chromium layers which, in particular, have different chromium contents. At the same time, the aluminum-chromium layers have the advantage that they can be produced with different chromium contents in locally different regions in a single operation.

Accordingly, aluminum-chromium layers according to the invention are produced by chromizing the component surface to be protected in a first substep and carrying out alitizing in a second substep. The chromizing and/or alitizing can be carried out simultaneously in various local regions of the component surface to be protected but can also be carried out differently so that different regions corresponding to the different protective requirements are formed in the protective layer.

The deposition of chromium in the first substep of chromizing may be carried out by means of thermochemical processes, thermophysical processes, physical processes or electrochemical processes.

For the present purposes, thermochemical processes are gas diffusion depositions in which chromium is provided at the component surface using heat and chemical reactions, so that the chromium can diffuse into the component and/or deposit on the latter.

In the case of PVD (physical vapor deposition) processes, vaporization and corresponding deposition of chromium is brought about using heat. In electrochemical processes, deposition of chromium from an electrolyte is brought about in the presence of an electric potential. The deposition of chromium can also be achieved by means of dispersion coating. A combination of the latter two processes is also conceivable. Here, an applied layer can in this case be produced by means of chemical and/or electrochemical deposition of chromium and further constituents, e.g. nickel, and additionally incorporated particles.

Diffusion of chromium into the component surface to form a chromium-rich layer after application to the component surface to be protected can be effected by an appropriate heat treatment, where, in the case of thermochemical and thermophysical processes, too, in which application is carried out at appropriately high temperatures and diffusion of chromium into the component surface is made possible during application, a further heat treatment to effect further diffusion of the chromium into deeper regions of the component may additionally be carried out.

In the first substep of chromizing, various chromium contents may be deposited to form the different protective layer regions in the various regions by, for example, applying chromium-containing materials in different amounts or using different concentrations of chromium. The deposition of different chromium contents can be carried out so that a chromium content of from 15% by weight to 100% by weight can be present in the resulting chromium-enriched layer.

In the chromizing, it is also possible to produce different thicknesses of the chromium-enriched layers, with, in particular, the layer thicknesses being able to vary in the range from 5 μm to 150 μm.

To form a first, outer surface layer having a high chromium content, chromizing can be carried out at a high chromium activity, with the chemical activity being able to be ≧0.4 or 40 percent, respectively. This can be achieved, for example, by powder pack processes or gas-phase chromizing.

Chromizing can, in particular, be carried out by a heat treatment in the presence of liquid, chromium-rich slip layers, where the slip can comprise chromium-containing powders together with activators and binders. Possible binders include alcohols or other solvents, while halides may be used as activator. The slip may be applied by physical methods such as painting or spraying.

When using a chromium-containing slip having chromium activities (chemical activity) of more than 0.4 or 40% for high-chromium subregions of the AlCr layer to be produced, a chromium-rich layer having a layer thickness of from 10 μm to 150 μm, and a chromium content of greater than or equal to 40% by weight, in particular from 50% by weight to 95% by weight, may be formed in a thermal and/or thermochemical treatment in a temperature range of from 1000° C. to 1180° C., in particular from 1050° C. to 1100° C., for periods of from 2 to 20 hours, in particular from 10 to 15 hours. The chromium-rich layer here has an outer a-chromium sublayer and an inner mixed crystal layer comprising essentially chromium and the main constituent of the alloy of the coated component, e.g. nickel.

In general, the chromizing in the first substep can be carried out at a temperature of from 1000° C. to 1180° C., in particular from 1050° C. to 1130° C., for a period of from 1 to 20 hours, in particular from 10 to 15 hours.

After production of the chromium-rich layer having preferably different chromium contents and/or different layer thicknesses in the various regions of the component which is to be provided with different AlCr layers, the base material which has been treated in this way, for example a component of a gas turbine or of an aircraft engine, is subjected to an alitizing process in which the component is, for example, packed in a powder packing having a high aluminum activity (chemical activity) in the range of greater than or equal to 0.15 or 15%, respectively, and treated thermally or thermochemically at temperatures of more than 1050° C. for a period of from 2 to 14 hours. Gas-phase alitizing can also be used. Regions without alitizing can remain, in particular when these regions are appropriately covered. The aluminum activity can preferably be in the range from 0.15 to 0.35. Possible powder packings include mixtures of aluminum oxide powders, aluminum powder and a halide as activator, so that aluminum can diffuse in an amount of from 10% by weight to 30% by weight into the layer. In alitizing, too, locally different protective layers can be produced by means of locally different aluminum activities. Here, either only alitizing can be carried out locally differently for uniformly produced Cr-rich layers or can be combined with the above-described locally different chromizing.

The alitizing at a chemical aluminum activity of greater than or equal to 0.15 or 15% may be followed by a second alitizing at a lower chemical aluminum activity, which chemical aluminum activity can be selected in the range from 0.05 to 0.3. The aging temperature in this second alitizing step may be greater than or equal to 1050° C. and the aging time may be from 3 to 20 hours.

In addition, the chromizing and alitizing may be followed by a diffusion heat treatment at a temperature of greater than or equal to 1050° C. for a period of from 2 to 8 hours.

A surface treatment by physical vapor deposition (PVD), chemical vapor deposition (CVD), surface coating, electrochemical deposition and/or direct application of a material in which one or more elements of the group consisting of platinum, palladium, hafnium, zirconium, yttrium and silicon are applied may be carried out before, during or after chromizing and/or alitizing. In this way, one or more of these elements can be introduced into the layer in order to exert an additional positive influence on the layer properties.

Accordingly, components such as turbine blades for stationary gas turbines or aircraft engines which have a protective layer which has chromium and aluminum as major constituents and has different regions which differ in terms of their composition in respect of the chromium and/or aluminum content can be produced by the above process. According to one aspect of the present invention, for which protection is sought both independently and in combination with other aspects of the present invention, the protective layer has at least two different regions which comprise different surface layers. The surface layer, i.e. the outer layer of the component which comes into contact with the surrounding atmosphere, can be either a high-chromium AlCr layer, an AlCr layer having moderate aluminum contents and low chromium contents or a layer having moderate chromium contents and moderate aluminum contents.

### BRIEF DESCRIPTION OF THE DRAWINGS

The accompanying drawings show, purely schematically, in

FIG. 1 a turbine blade and a temperature-location diagram which indicates the temperature profile over the blade; and in

FIG. 2 a ternary phase diagram for the system chromium-aluminum-nickel which shows the regions of the composition of the different layer compositions according to the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show details of the present invention in more detail than is necessary for the fundamental understanding of the present invention, the description in combination with the drawings making apparent to those of skill in the art how the several forms of the present invention may be embodied in practice.

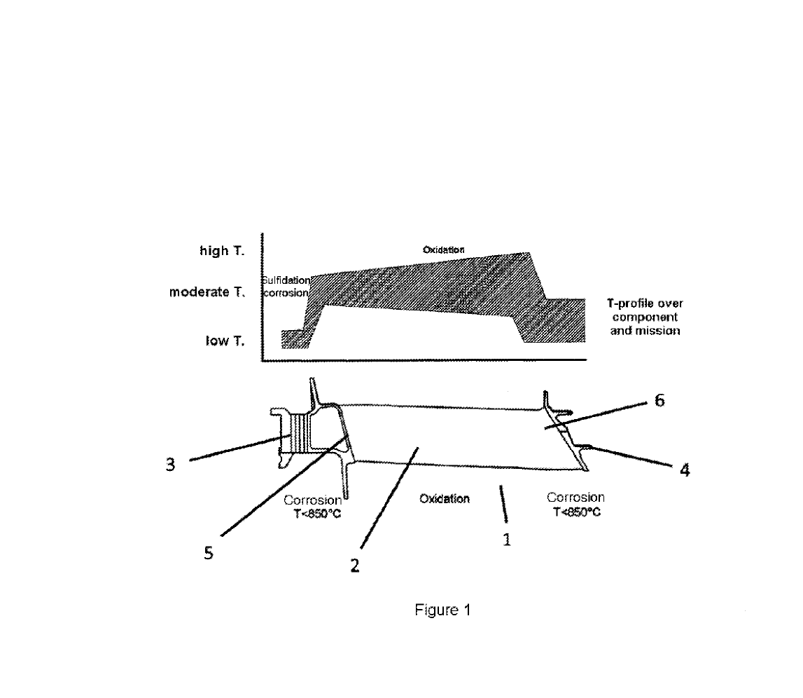

FIG. 1 shows a turbine blade as can be used, for example, in a stationary gas turbine or in an aircraft engine. The turbine blade 1 has a blade 2, an inner covering band 3 and an outer covering band 4. In addition, FIG. 1 depicts a temperature-location diagram over the turbine blade 1 so as to show the temperature profile over the blade during use. As can be seen from the diagram, lower temperatures are to be expected outside the gas flow region at the inner covering band 3 and at the outer covering band 4 than in the blade region 2. At the transitions 5, 6 from the blade 2 to the inner covering band 3 and from the blade 2 to the outer covering band 4, in-between temperatures accordingly occur.

In the case of the atmospheres prevailing in gas turbines or aircraft engines, corrosion attacks, in particular in the form of sulfidation, occur at low temperatures in the range below 900° C., while hot gas oxidation predominates at higher temperatures above 900° C. However, mixed attack involving hot gas oxidation and hot gas corrosion, in particular sulfidation, is observed in particular in the transition regions having in-between temperatures. In the case of sulfidation, a distinction can be made, according to the temperature at which sulfidation takes place, between sulfidation type 1 at about 900° C. and sulfidation type 2 at temperatures in the region of 700° C.

In order to be protected against the various oxidation and corrosion attacks, the turbine blade 1 is provided with different protective layers, with protective layers based on chromium and in particular high-chromium AlCr layers being formed in the inner covering band region or outer covering band region, while protective layers based on aluminum or platinum-aluminum and in particular AlCr layers having a low chromium content being formed in the blade region 2, while aluminum-chromium layers having a moderate chromium content are applied in the transition regions 5, 6.

The aluminum-chromium layers having a high chromium content form a first outer surface layer having chromium contents in the range from 40 to 90% by weight and aluminum contents in the range from 5 to 35% by weight. Depending on the base material present in the turbine blade, up to 55% by weight, preferably up to 30% by weight, of the main constituents of the base material, in particular of the main constituent such as nickel, cobalt or iron are present in a first outer surface layer, depending on whether the base material of the component to be protected is a nickel-based alloy, cobalt-based alloy or iron-based alloy.

The AlCr layers having a low chromium content form another, second outer surface layer which has chromium contents in the range from 5% by weight to 15% by weight and aluminum contents in the range from 5% by weight to 35% by weight. The proportion of constituents of the base alloy and in particular the main constituent of the base alloy is in the range from 50% by weight to 75% by weight.

The aluminum-chromium layers having a moderate chromium content form a further, third outer surface layer which has chromium contents in the range from 15% by weight to 40% by weight, aluminum contents of from 5% by weight to 35% by weight, preferably from 15% by weight to 35% by weight, and constituents of the base alloy in amounts of up to 70% by weight.

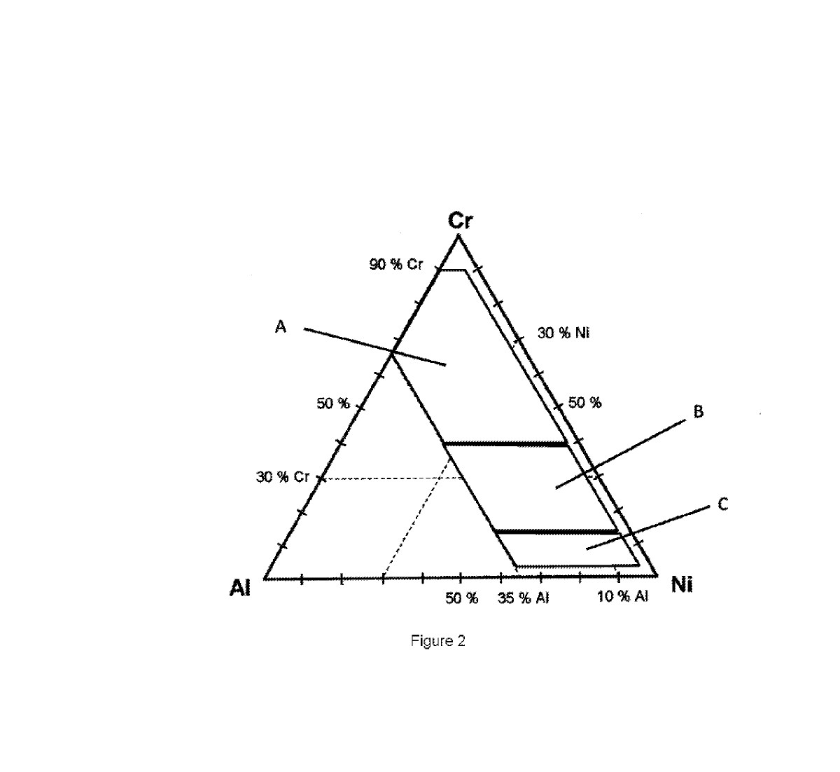

In the ternary phase diagram of FIG. 2 for the system aluminum-chromium-nickel, the various compositions of the first, second and third surface layers are shown for the example of a nickel-based alloy as base material of the turbine blade. For the regions of the turbine blade which are subject to corrosion and sulfidation attack, namely the surfaces of the inner covering bands 3 and the outer covering bands 4 which are arranged outside the gas channel, first surface layers are provided in the form of high-chromium aluminum-chromium layers which in the ternary phase diagram shown are located in the region A close to the chromium apex. To effect oxidation protection in the region of the blade 2, second surface layers are provided in the form of low-chromium aluminum-chromium alloy layers which in the ternary phase diagram are located in region C close to the nickel corner. In-between, there are AlCr layers which have compositions having a moderate chromium content and are used as third surface layers for the transition regions 5, 6 which are present in the gas channel and in the case of which both high-temperature oxidation and corrosion occur.

In the examples, coating of the entire component, i.e., for example, the turbine blade, with a layer according to the invention composed of aluminum and chromium has been described. However, combination of a protective layer according to the invention with aluminum-chromium layers, also in combination with other known protective layers, is of course also possible.

In the case of the aluminum-chromium protective layer according to the invention, the term coating refers not only to a deposit of the deposited aluminum and chromium on the original component surface, but the protective layer can also extend from the original component surface inward into the interior of the material.

In addition, the description of the examples has merely been concerned with the formation of an outer protective layer, but this can be merely a sublayer of the protective layer system produced, so that further sublayers which differ in terms of their composition and structure can be formed in a direction perpendicular to the component surface in the direction of the interior of the material.

The alitizing and/or chromizing described here is also suitable for the interior coating of hollow blades.

The above process can preferably be applied to gas turbine components or aircraft engine components. The component may be made of an alloy which has a metallic main constituent which makes up the major proportion of the alloy together with a protective layer for protection against high temperatures and aggressive media, where the protective layer comprises chromium and aluminum and has, in particular, been produced by a process as claimed in any of the preceding claims and the protective layer has different regions which differ in terms of their composition in respect of the chromium and/or aluminum content. The protective layer may have at least two different regions which each have a surface layer from the group of a first surface layer having a chromium content of greater than or equal to 40% by weight, an aluminum content of from 5% by weight to 35% by weight and a proportion of the main constituent of the component of less than or equal to 55% by weight, a second surface layer having a chromium content of from 5% by weight to 15% by weight, an aluminum content of from 10% by weight to 35% by weight and a proportion of the main constituent of the component of from 50% by weight to 75% by weight and a third surface layer having a chromium content of from 15% by weight to 40% by weight, an aluminum content of from 15% by weight 35% by weight and a proportion of the main constituent of the component of less than or equal to 70% by weight.

In the first surface layer of the component, the proportion of chromium may be in the range from 40% by weight to 90% by weight, preferably greater than or equal to 50% by weight, and/or the proportion of aluminum may be in the range from 5% by weight to 25% by weight and/or the proportion of the main constituent of the component can be less than or equal to 30% by weight. The proportion of Al in the second surface layer is preferably from 20% by weight to 35% by weight.

In the third surface layer of the component, the proportion of chromium can be in the range from 20% by weight to 40% by weight and/or the proportion of aluminum can be in the range from 20% by weight to 35% by weight.

The different regions of the protective layer are selected according to the temperature and/or the ambient atmosphere during operation of the component.

The component may be a rotor blade or guide blade of a flow machine, in particular a gas turbine or an aircraft engine, which is at least partly coated with the protective layer, with, in particular, additional other layer systems being able to be provided.

The first surface layer may be arranged in regions subjected predominantly to sulfidation and/or regions having operating temperatures in the range from 550° C. to 900° C.

The second surface layer of the component may be arranged in regions which are subjected predominantly to oxidation and/or regions having operating temperatures of greater than or equal to 900° C.

The third surface layer may be arranged in regions which are subjected to combined oxidation and sulfidation.

The first surface layer may be arranged in the base and/or covering band region of the blade and/or the second surface layer may be arranged in the blade region of the blade and/or the third surface layer may be arranged in the transition region base/blade and/or blade/covering band.

The layer thickness of the protective layer may be from 10 μm to 250 μm, in particular from 40 μm to 150 μm.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A process for producing a protective layer for protecting a component against high temperatures and aggressive media, wherein the process comprises forming a surface layer comprising aluminum and chromium on a surface of the component to be provided with the protective layer by (i) chromizing and (ii) alitizing, the chromizing and/or the alitizing in different regions of the component surface to be protected being carried out simultaneously but differently to result in the protective layer having different regions.

2. The process of claim 1, wherein in (i) chromium is deposited by a thermochemical process or a thermophysical process or an electrochemical process.

3. The process of claim 1, wherein in (i) a heat treatment is carried out.

4. The process of claim 1, wherein in (i) different chromium contents are deposited in the different regions.

5. The process of claim 4, wherein in the different regions chromium contents of the layer formed vary from 15% to 100% by weight.

6. The process of claim 1, wherein in (i) chromium-enriched layers having different thicknesses are deposited in the different regions.

7. The process of claim 6, wherein the layer thicknesses in the different regions vary from 5 μm to 150 μm.

8. The process of claim 1, wherein (i) is carried out at a chemical chromium activity of greater than or equal to 0.4 to form a first surface layer.

9. The process as claimed in claim 8, wherein (i) is carried out using a Cr-rich slip which contains liquid phases.

10. The process of claim 8, wherein (i) is carried out in such a way that a chromium-rich layer having an outer α-chromium sublayer and an inner mixed crystal layer essentially composed of chromium and a main constituent which has a largest proportion in an alloy of the coated component is formed.

11. The process of claim 10, wherein a chromium content of the chromium-rich layer is greater than or equal to 40% by weight.

12. The process of claim 1, wherein (i) is carried out at a temperature of from 1000° C. to 1200° C. for a period of from 1 to 20 hours.

13. The process of claim 1, wherein (ii) is carried out at a temperature of from 1000° C. to 1150° C. for a period of from 2 to 20 hours.

14. The process of claim 1, wherein a chemical aluminum activity during (ii) is greater than or equal to 0.15.

15. The process of claim 14, wherein the chemical aluminum activity is from 0.15 to 0.35

16. The process of claim 1, wherein a first alitizing is followed by a second alitizing at a lower chemical aluminum activity.

17. The process of claim 1, wherein (i) and (ii) are followed by a diffusion heat treatment at a temperature of greater than or equal to 1050° C. for a period of from 2 to 8 hours.

18. The process of claim 1, wherein a surface treatment by PVD, CVD, surface coating, electrochemical deposition and/or direct application of a material, in which one or more elements selected from platinum, palladium, hafnium, zirconium, yttrium and silicon are applied, is carried out before, during or after (i) and/or (ii).

19. A component which comprises a protective layer produced according to the process of claim 1.

20. The component of claim 19, wherein the component is a part of a gas turbine or aircraft engine.
